(19) United States
(12) Patent Application Publication
(10) Pub. No.: US 2025/0297460 A1
(43) Pub. Date: Sep. 25, 2025

(54) HYDRAULIC SYSTEM FOR RECOVERING BOOM ENERGY FOR CONSTRUCTION MACHINERY

(71) Applicant: READI ROBUST MACHINE CO., LTD., Busan (KR)

(72) Inventor: Tae Rang JUNG, Gyeongsangnam-do (KR)

(21) Appl. No.: 18/869,630

(22) PCT Filed: May 25, 2023
(86) PCT No.: PCT/KR2023/007214

§ 371 Date: Nov. 26, 2024

(30) Foreign Application Priority Data
May 27, 2022 (KR) 10-2022-0065457
May 23, 2023 (KR) 10-2023-0066507

(51) Int. Cl. E02F 9/22; E02F 3/43

(52) U.S. Cl. CPC E02F 9/2278; E02F 3/43; E02F 9/2225

(57) ABSTRACT

The present disclosure relates to a hydraulic system for recovering boom energy for construction machinery, and more particularly, to a hydraulic system for recovering boom energy for construction machinery, which is capable of recovering boom energy wasted in the event of boom-down. According to the present disclosure, the hydraulic system is able to have a simplified structure, to minimize the number of valves while maximizing boom energy recovery, and to be easily installed in or detached from existing construction machinery.

### TECHNICAL FIELD

The present disclosure relates to a hydraulic system for recovering boom energy for construction machinery, and more particularly, to a hydraulic system for recovering boom energy for construction machinery, which is capable of recovering boom energy in construction machinery.

### BACKGROUND ART

Forklifts or excavators are construction machines that are typically used for digging into or cutting the ground, and are widely used in construction sites and various industrial sites. These forklifts may each include a boom having an end movable along a curved trajectory, and the end of the boom may be equipped with different tools including buckets.

The boom is connected with a hydraulic cylinder, and the hydraulic cylinder drives the boom while moving up and down. The hydraulic cylinder is moved up and down by means of the flow of oil in hydraulic systems. The forklift includes a power means such as an engine. The engine may provide force for the flow of oil in hydraulic systems and at the same time provide power for the movement of the forklift.

Typically, the forklift consumes a lot of fuel when moving because it is very heavy. In addition, a lot of fuel is consumed to drive the boom because the dead weight of the boom is large.

With the recent emergence of green issues, various technologies are developed and researched to improve fuel efficiency in the field of construction machinery such as forklifts. For example, a technology or the like has been proposed to assist in the movement of a forklift or the actuation of a boom by recovering the potential energy of the boom and then temporarily storing it when the boom of the forklift is moved down.

However, these conventional technologies may reduce work efficiency due to great restrictions on the working operation or working speed of the boom or the like, and may be very difficult to install on a variety of existing forklifts.

Meanwhile, various methods have been proposed to recover boom energy in conventional construction machinery, one of which is to recover boom energy by controlling multiple valves installed in construction machinery.

However, a large number of valves are required to recover boom energy, which may lead to the complexity of the entire system and an increase in overall device cost due to valve installation and manufacturing costs.

### PRIOR ART LITERATURE

### Patent Document

(Patent Document 1) Korean Patent No. 10-2309862

### DISCLOSURE

### Technical Problem

The present disclosure has been made in view of the technical background as described above, and is directed to use for construction machinery. An object of the present disclosure is to provide a hydraulic system for recovering boom energy for construction machinery, which is capable of having a simplified structure to recover boom energy wasted in the event of boom-down, of minimizing the number of valves while maximizing boom energy recovery, and of being easily installed in or detached from existing construction machinery.

### Technical Solution

In accordance with an aspect of the present disclosure, there is provided a hydraulic system for recovering boom energy for construction machinery, which is installed in a construction machine to recover energy during boom-down by controlling a flow of oil, wherein the construction machine includes a cylinder including a rod raised and lowered by means of the flow of oil, a large chamber, and a small chamber formed on the large chamber, an engine configured to provide the flow of oil to the cylinder, and an accumulator connected to the cylinder and the engine to accumulate oil. The hydraulic system includes a main control valve connected to the cylinder to selectively control the flow of oil provided to the cylinder, a hydraulic motor assembly connected to the engine to provide the engine with a rotational force generated by means of a fluid, a main pipe connected to the cylinder, and a valve assembly including a plurality of lines connected to the main pipe and through which oil flows, and a valve installed in a selected one of the plurality of lines.

The valve assembly may include a first line having one side connected to the large chamber in the cylinder, a second line connecting the first line and the accumulator, a fifth line having one side connected to the small chamber in the cylinder, a sixth line branched from the first line and connected to the fifth line, and a seventh line branched from the first line and connected to an oil tank.

The second line may be provided with an AC valve that controls a flow rate of oil.

When the boom is moved down, the AC valve may be opened to control the flow rate of oil such that the oil discharged from the cylinder flows only toward the accumulator through the first line and the second line, thereby charging the accumulator with oil.

The sixth line may be provided with an AB valve that controls a flow rate of oil.

When the boom is moved down, the AB valve may be opened to control the flow rate of oil such that the oil discharged from the large chamber in the cylinder flows into the accumulator through the first line, and at the same time, some of the oil flows into the small chamber through the sixth line and the fifth line, thereby regenerating oil.

The seventh line may be provided with an AR valve that controls a flow rate of oil.

When the boom is moved down, the AR valve may be opened if the accumulator is full of the oil introduced through the first line and the second line, thereby controlling the flow rate of oil flowing to the accumulator to return some of the oil to the oil tank.

The hydraulic motor assembly may include a variable hydraulic motor configured to generate a rotational force when oil is introduced thereinto, and the variable hydraulic motor may be controlled in torque to adjust an amount of oil introduced thereinto.

### Advantageous Effects

According to the present disclosure, a hydraulic system for recovering boom energy for construction machinery has an effect in that it is able to have a simplified structure to recover boom energy wasted in the event of boom-down, to minimize the number of valves while maximizing boom energy recovery, and to be easily installed in or detached from existing construction machinery.

### BRIEF DESCRIPTION OF DRAWINGS

FIG. 1 is a conceptual view illustrating an overall appearance of a construction machine according to an embodiment of the present disclosure.

FIG. 2 is a schematic diagram illustrating a hydraulic system for recovering boom energy for construction machinery according to an embodiment of the present disclosure.

FIG. 3 is a perspective view illustrating a hydraulic motor assembly according to the embodiment of the present disclosure.

FIG. 4 is a top view illustrating an accumulator assembly according to the embodiment of the present disclosure.

FIG. 5 is a perspective view illustrating the accumulator assembly according to the embodiment of the present disclosure.

FIG. 6 is a top view illustrating a bracket cut out from the accumulator assembly according to the embodiment of the present disclosure.

FIG. 7 is a schematic diagram illustrating charging in the hydraulic system for recovering boom energy for construction machinery during boom-down motion of a boom according to the embodiment of the present disclosure.

FIG. 8 is a schematic diagram illustrating regeneration in the hydraulic system for recovering boom energy for construction machinery during boom-down motion of the boom according to the embodiment of the present disclosure.

FIG. 9 is a schematic diagram illustrating return in the hydraulic system for recovering boom energy for construction machinery during boom-down motion of the boom according to the embodiment of the present disclosure.

### LIST OF REFERENCE NUMERALS

100: construction machine
110: body
120: engine
121: shaft
122: main pump
123: auxiliary pump
130: boom
140: cylinder
141: rod
142: large chamber
143: small chamber
144: large chamber line
145: small chamber line
150: cabinet
151: joystick
160: main control valve
161: spool
162: main valve line
163: boom-up valve
164: boom-down valve
165: boom-up valve line
166: boom-down valve line
170: controller
200: accumulator assembly
210: bracket
211: mount
212: hollow
213: groove
220: accumulator
230: valve assembly
240: main pipe
241: joint block
250: pilot pipe
300: hydraulic motor assembly
310: hydraulic motor
400: mobile device
AC: AC valve
AB: AB valve
AR: AR valve
RE: release valve
SOL: solenoid valve
L1: first line
L2: second line
L4: fourth line
L5: fifth line
L6: sixth line
L7: seventh line
L8: eighth line
S1: first sensor
S2: second sensor
S3: third sensor
S4: fourth sensor
S5: fifth sensor
T1: first oil tank
T2: second oil tank
T3: third oil tank
T4: fourth oil tank

### BEST MODE

The present disclosure provides a hydraulic system for recovering boom energy for construction machinery, which is installed in a construction machine to recover energy during boom-down by controlling a flow of oil, wherein the construction machine includes a cylinder including a rod raised and lowered by means of the flow of oil, a large chamber, and a small chamber formed on the large chamber, an engine configured to provide the flow of oil to the cylinder, and an accumulator connected to the cylinder and the engine to accumulate oil. The hydraulic system includes a main control valve connected to the cylinder to selectively control the flow of oil provided to the cylinder, a hydraulic motor assembly connected to the engine to provide the engine with a rotational force generated by means of a fluid, a main pipe connected to the cylinder, and a valve assembly including a plurality of lines connected to the main pipe and through which oil flows, and a valve installed in a selected one of the plurality of lines.

### Mode for Disclosure

Various modifications and different embodiments will be described below in detail with reference to the accompanying drawings so that those skilled in the art can easily carry out the disclosure. It should be understood, however, that the present disclosure is not intended to be limited to the specific embodiments, but the present disclosure includes all modifications, equivalents or replacements that fall within the spirit and scope of the disclosure as defined in the following claims.

The terminology used herein is for the purpose of describing specific embodiments only and is not intended to limit the scope of the disclosure. As used herein, the singular forms “a”, “an” and “the” are intended to include the plural forms as well, unless the context clearly indicates otherwise.

In the disclosure, terms such as “comprises”, “includes”, or “have/has” should be construed as designating that there are such features, integers, steps, operations, components, parts, and/or combinations thereof, not to exclude the presence or possibility of adding of one or more of other features, integers, steps, operations, components, parts, and/or combinations thereof. Reference will now be made in detail to exemplary embodiments of the present disclosure, examples of which are illustrated in the accompanying drawings. It should be noted that like reference numerals refer to like parts throughout various drawings and exemplary embodiments.

In certain embodiments, a detailed description of functions and configurations well known in the art may be omitted to avoid obscuring appreciation of the disclosure by those skilled in the art. For the same reason, some components may be exaggerated, omitted, or schematically illustrated in the accompanying drawings.

Hereinafter, a hydraulic system for recovering boom energy for construction machinery and a construction machine including the same according to the present disclosure will be described in detail with reference to the accompanying drawings.

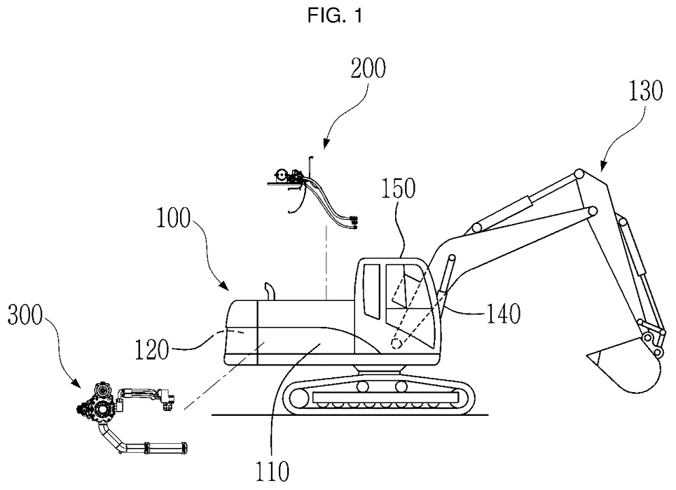

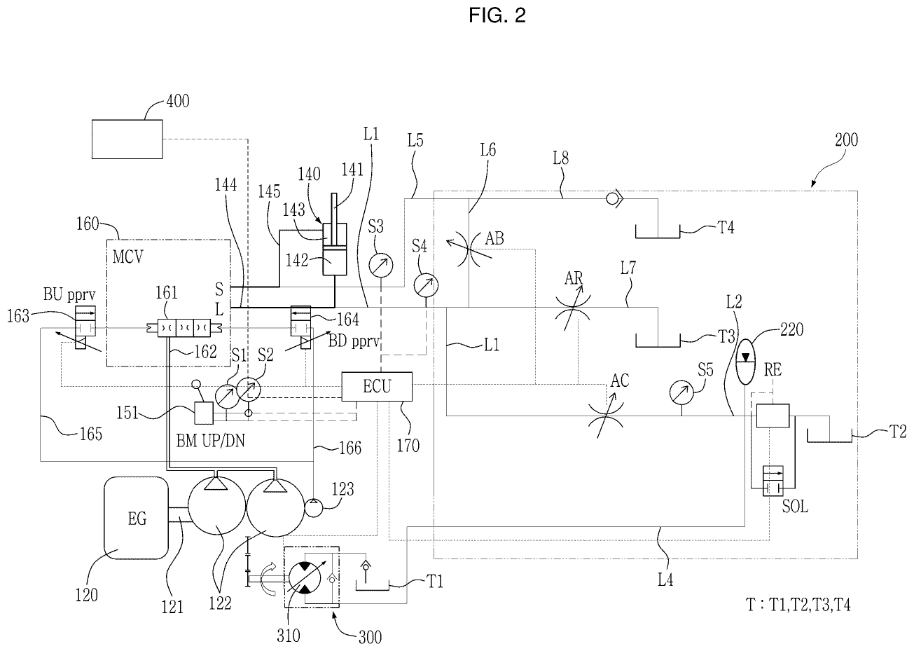

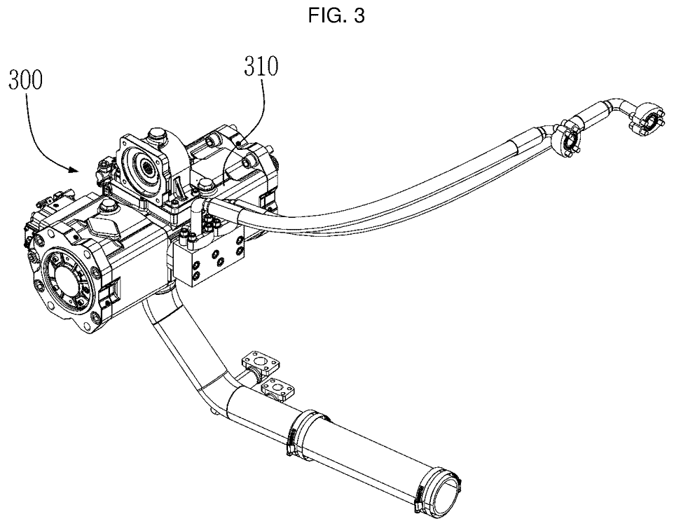

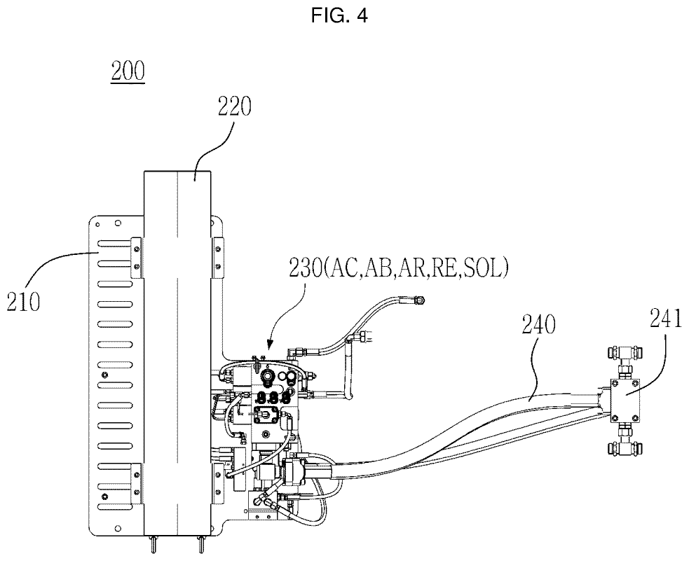

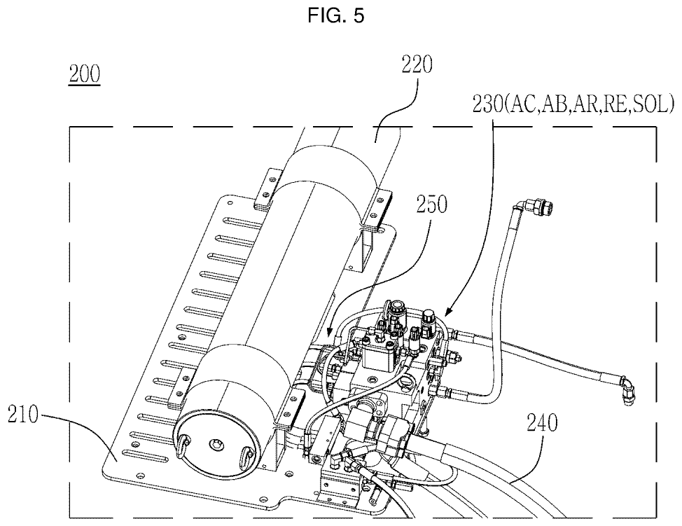

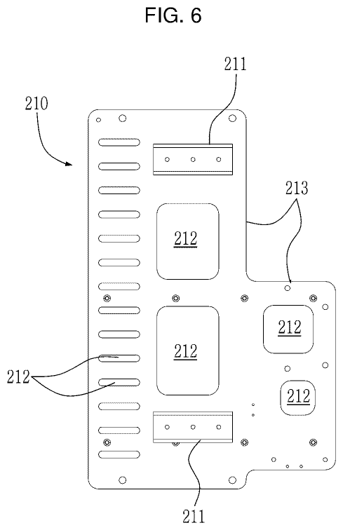

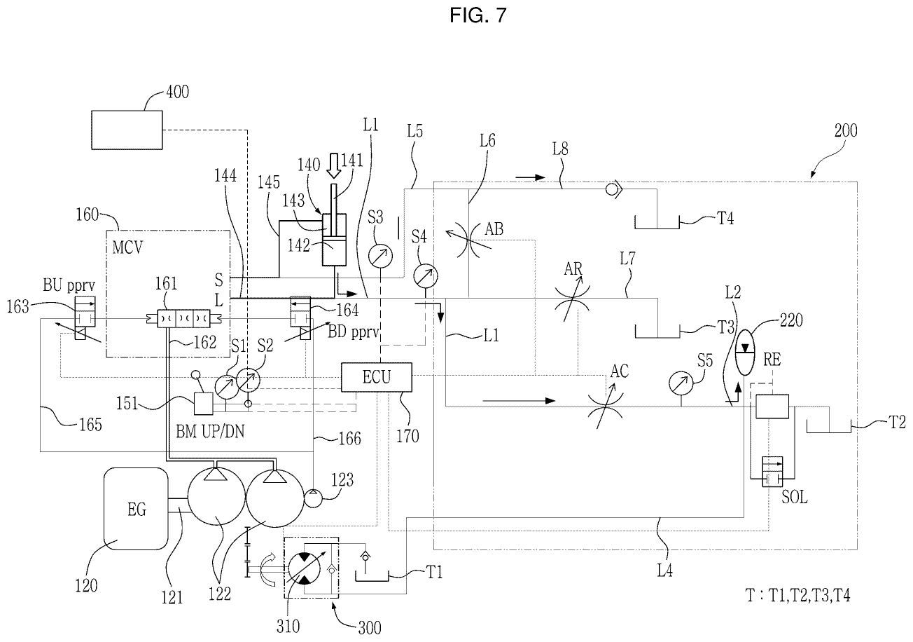

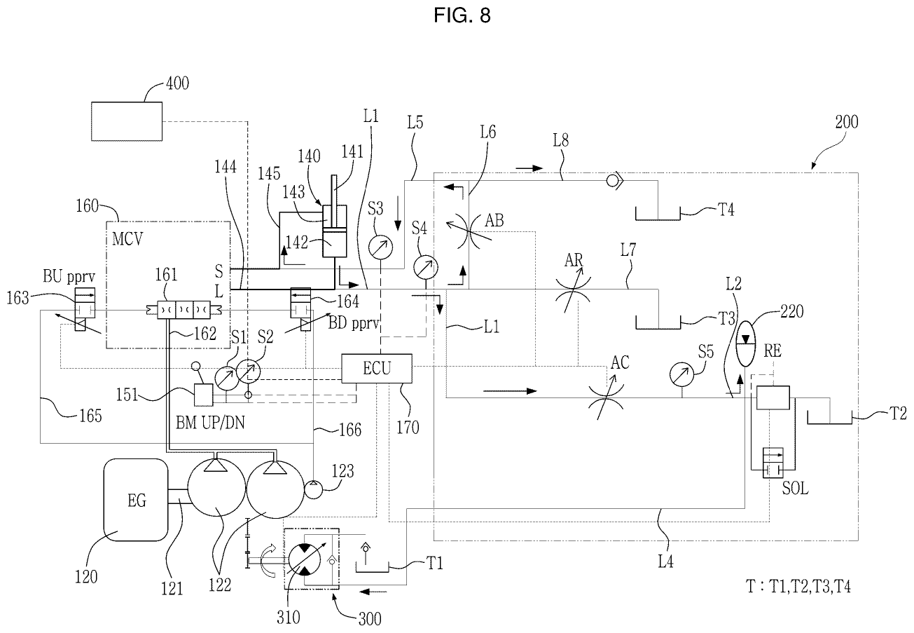

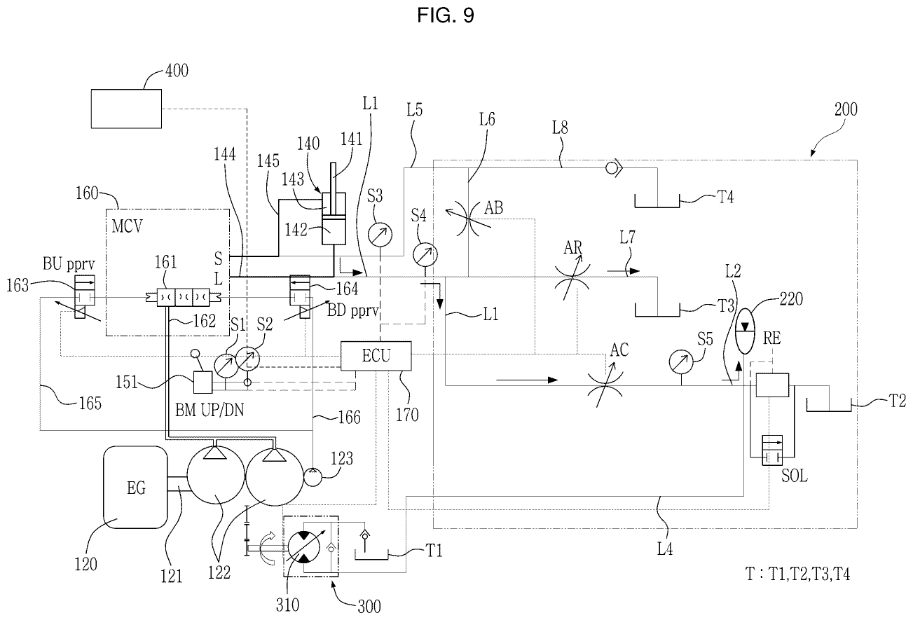

FIG. 1 is a conceptual view illustrating an overall appearance of a construction machine according to an embodiment of the present disclosure. FIG. 2 is a schematic diagram illustrating a hydraulic system for recovering boom energy for construction machinery according to an embodiment of the present disclosure. FIG. 3 is a perspective view illustrating a hydraulic motor assembly according to the embodiment of the present disclosure. FIG. 4 is a top view illustrating an accumulator assembly according to the embodiment of the present disclosure. FIG. 5 is a perspective view illustrating the accumulator assembly according to the embodiment of the present disclosure. FIG. 6 is a top view illustrating a bracket cut out from the accumulator assembly according to the embodiment of the present disclosure. FIG. 7 is a schematic diagram illustrating charging in the hydraulic system for recovering boom energy for construction machinery during boom-down motion of a boom according to the embodiment of the present disclosure. FIG. 8 is a schematic diagram illustrating regeneration in the hydraulic system for recovering boom energy for construction machinery during boom-down motion of the boom according to the embodiment of the present disclosure. FIG. 9 is a schematic diagram illustrating return in the hydraulic system for recovering boom energy for construction machinery during boom-down motion of the boom according to the embodiment of the present disclosure.

Referring to FIGS. 1 to 6, the hydraulic system for recovering boom energy for construction machinery according to the embodiment of the present disclosure has a structure that may be installed in and detached from a construction machine 100, and may include a main control valve 160, a hydraulic motor assembly 300, a main pipe 240, and a valve assembly 230. The hydraulic system may be installed in connection with a body 110, a cylinder 140, an engine 120, an accumulator 220 of an accumulator assembly 200, and a boom 130 of the construction machine 100.

Specifically, the boom 130 and the cylinder 140 may be connected to the body 110. The cylinder 140 may be moved up and down by means of the flow of oil, and the boom 130 may be rotated by the upward and downward movement of the cylinder 140.

The engine 120 may be placed inside the body 110. The engine 120 may provide the cylinder 140 with the flow of oil. The engine 120 may provide a driving force to a drive unit (not shown) placed at the bottom of the body 110.

The operation of the cylinder 140 will be discussed in more detail as follows. The construction machine 100 may have a cabinet 150 placed in the body 110 for an operator to board. The cabinet 150 may be provided with a joystick 151 for controlling the boom-up or boom-down motion of the boom 130.

Specifically, the cylinder 140 may include a rod 141 that is raised and lowered by means of the flow of oil and connected to the boom 130. The cylinder 140 may include a large chamber 142 and a small chamber 143 formed on the large chamber 142.

The rod 141 may be placed between the small chamber 143 and the large chamber 142 in the cylinder 140. The rod 141 may be raised when oil enters the large chamber 142, and may be lowered when oil enters the small chamber 143. The boom 130 may be moved up when the rod 141 is raised, and the boom 130 may be moved down when the rod 141 is lowered.

The main control valve 160 may be connected to the cylinder 140 to selectively control the flow of oil provided to the cylinder 140. The main control valve 160 may be placed on the construction machine 100.

The main control valve 160 may be connected to the large chamber 142 through a large chamber line 144, and the main control valve 160 may be connected to the small chamber 143 through a small chamber line 145.

The main control valve 160 may have a spool 161 placed thereon.

The spool 161 enables oil to flow toward the small chamber 143 or toward the large chamber 142. In other words, the rod 141 of the cylinder 140 may be raised or lowered by the operation of the spool 161 placed on the main control valve 160.

The engine 120 may be equipped with a shaft 121, which is connected to a main pump 122. The main pump 122 and the spool 161 may be connected to a main valve line 162, and oil may flow to the spool 161 and the main control valve 160 through the main valve line 162.

The spool 161 may be controlled by a boom-up valve 163 and a boom-down valve 164. An auxiliary pump 123 may be connected to the shaft 121 of the engine 120. The auxiliary pump 123 and the spool 161 may be connected to a boom-up valve line 165, and the boom-up valve 163 may be placed in the boom-up valve line 165. The auxiliary pump 123 and the spool 161 may be connected to a boom-down valve line 166, and the boom-down valve 164 may be placed in the boom-down valve line 166. When the boom-up valve 163 is opened, the spool 161 may move so that oil flows to the large chamber 142. When the boom-down valve 164 is opened, the spool 161 may move so that oil flows to the small chamber 143.

The hydraulic motor assembly 300 may be connected to the engine 120 that provides the flow of oil, to provide the engine with a rotational force generated by means of a fluid.

The hydraulic motor assembly 300 may include a variable hydraulic motor 310. The variable hydraulic motor 310 is a device that generates a rotational force by means of a fluid, and the rotational force may be variably generated when oil flows into the hydraulic motor 310.

The rotary shaft of the variable hydraulic motor 310 may be connected to the shaft 121 of the engine 120. Accordingly, the variable hydraulic motor 310 may variably provide a rotational force to the shaft 121. The hydraulic motor assembly 300 may have a pipe through which oil is introduced into or discharged from the variable hydraulic motor 310, and may also have a pipe connected to a first oil tank T1 to be described later.

The variable hydraulic motor 310 of the hydraulic motor assembly 300 may be installed in an engine room where the engine 120 is placed in the construction machine 100. For this purpose, the variable hydraulic motor 310 may have a fastener (not shown) for fastening to the engine room. Besides, a pipe through which oil may be introduced or discharged, a pipe connected to the first oil tank T1, etc. may be provided for connection to corresponding pipes in existing construction machinery.

The variable hydraulic motor 310 may be controlled in torque by a controller 170 to be described later, and the torque of the variable hydraulic motor 310 may be controlled to adjust the amount of oil introduced thereinto.

The accumulator assembly 200 may be connected to the cylinder 140 to discharge accumulated oil to the cylinder 140, and the oil in the cylinder 140 may be introduced and accumulated. Specifically, the accumulator assembly 200 includes a bracket 210, an accumulator 220, a valve assembly 230, and a main pipe 240.

The bracket 210 is detachably fastened to the body 110 of the construction machine 100, and the accumulator 220, the valve assembly 230, and the main pipe 240 are arranged on the bracket 210. The bracket 210 is a component installed on the construction machine 100, and on which the accumulator 220, the valve assembly 230, and the main pipe 240 are arranged.

The bracket 210 may have a thin plate shape or a plate shape. The bracket 210 may be placed on the outside of the construction machine 100. The bracket 210 may have a fastener (not shown) for fastening to the construction machine 100. The fastener (not shown) may be formed of, for example, a screw hole for insertion of a bolt thereinto or the like.

The main pipe 240 and the valve assembly 230 may be arranged on the front side of the bracket 210 facing the boom 130, the bracket 210 may have a hollow 212 formed on the rear side thereof, and the accumulator 220 may be placed between the front side and the rear side of the bracket 210. The bracket 210 may have a groove 213 formed on the front side thereof.

The groove 213 may be recessed rearwards from the front end of the bracket 210. The groove 213 may have a shape corresponding to the outer surface of the cabinet 150 of the construction machine 100, thereby minimizing spatial interference between the cabinet 150 and the bracket 210. The main pipe 240 and the valve assembly 230 may be arranged in an area of the front side of the bracket 210 where the groove 213 is not formed. In other words, the groove 213 may be formed on one area of the front side of the bracket 210, and the main pipe 240 and the valve assembly 230 may be arranged on the other area thereof.

The structure of this bracket 210 may allow the area of the bracket 210 where the main pipe 240 and the valve assembly 230 are arranged to be closer to the boom 130, thereby minimizing the length of various pipes or lines connected to the cylinder 140, resulting in minimal resistance against the flow of oil.

The hollow 212 may formed on the rear side of the bracket 210. The engine 120 may be placed on the rear side of the accumulator assembly 200. The hollow 212 may reduce the influence of heat generated by the engine 120 on the accumulator 220. The hollow 212 may also reduce the weight of the bracket 210. The hollow 212 may be formed on the rear side of the bracket 210, as well as at the center or on the front side of the bracket 210.

The accumulator 220 may be spaced apart from the rear end (end at the rear side) of the bracket 210. This makes it convenient to open the engine room to service the engine 120 and also easy for the operator to detach and install the accumulator 220, even when the accumulator assembly 200 is installed on the construction machine 100. Besides, it is possible to prevent direct transfer of the heat and vibration generated by the engine 120 to the accumulator 220.

The bracket 210 may have a mount 211 placed between the front side and the rear side thereof. The mount 211 is configured to mount the accumulator 220. The mount 211 may allow the accumulator 220 to be spaced apart from the upper surface of the bracket 210 by a predetermined distance. Accordingly, it is possible to facilitate the detachment and installation of the accumulator 220 and to prevent direct transfer of the heat and vibration generated by the engine 120 to the accumulator 220.

The bracket 210 may be detachably installed on the construction machine 100. The bracket 210 may be installed in a manner that renovates the exterior or interior of existing construction machinery. The specific size or detailed shape of the bracket 210 may be partially modified depending on the construction machine 100 to be installed. Owing to the configuration of this bracket 210, the hydraulic system according to the present disclosure may be easily and conveniently installed in a variety of existing construction machines.

The accumulator 220 may be configured to accumulate oil, and the oil accumulated in advance in the accumulator 220 may be discharged from the accumulator 220 if necessary. The main pipe 240 is connected to the cylinder 140. The valve assembly 230 is connected to the main pipe 240.

The opening and closing of the valve assembly 230 may be individually adjusted by a pilot pipe 250. Specifically, the valve assembly 230 may include a first line L1, a second line L2, a fifth line L5, a sixth line L6, and a seventh line L7, and may include an AC valve AC, an AB valve AB, and an AR valve AR.

The first line L1 is a line connected to the large chamber 142 in the cylinder 140. The first line L1 may be connected to the large chamber line 144. The second line L2 is a line connecting the first line L1 and the accumulator 220. The AC valve AC may be placed in the second line L2. The AC valve AC may be a charging valve that is provided to enable the control of the flow of oil and to control oil to flow only toward the accumulator 220 in the second line L2 to charge the accumulator 220 with oil.

When the boom 130 is moved down, the AC valve AC may be opened to control the flow rate of oil such that the oil discharged from the cylinder 140 flows only toward the accumulator 220 through the first line L1 and the second line L2, thereby charging the accumulator 220 with oil, and the accumulator 220 may accumulate the oil introduced thereinto.

The fifth line L5 is a line connected to the small chamber 143 in the cylinder 140. The fifth line L5 may be connected to the small chamber line 145. The sixth line L6 is a line that is branched from the first line L1 and connected to the fifth line L5. The AB valve AB may be placed in the sixth line L6 to enable the control of the flow rate of oil in the sixth line L6. The AB valve AB may be a regeneration valve that allows some of the oil flowing in the first line L1 to flow into the small chamber 143 in the cylinder 140 through the sixth line L6 and the fifth line L5.

The seventh line L7 is a line that is branched from the first line L1 and connected to a third oil tank T3 to be described later. The AR valve AR may be placed in the seventh line L7 to enable the control of the flow rate of oil in the seventh line L7. The AR valve AR may be a return valve that allows some of the oil flowing to the accumulator 220 to flow into an oil tank T if the accumulator 220 is full of oil.

The valve assembly 230 may include a fourth line L4 connecting the accumulator 220 and the variable hydraulic motor 310. Since the variable hydraulic motor 310 is installed capable of controlling the flow rate of oil, a separate valve is not required for the fourth line L4, but a CM valve CM (not shown) may be further provided capable of controlling the flow rate of oil.

Accordingly, the oil accumulated in the accumulator 220 may flow into the variable hydraulic motor 310 through the fourth line L4 to rotate the variable hydraulic motor 310.

The valve assembly 230 may further include an eighth line L8 connected to the fifth line L5 and the sixth line L6. The eighth line L8 may be connected to a fourth oil tank T4 to be described later. The oil that has passed through the AB valve AB may also flow into the fourth oil tank T4 through the eighth line L8.

The valve assembly 230 may include a release valve RE. The release valve RE is placed on the passage between the accumulator 220 and a second oil tank T2 to be described later. The release valve RE is operated in an on/off manner.

The valve assembly 230 may include a solenoid valve SOL connected in parallel to the release valve RE. Specifically, the solenoid valve SOL may be connected to the front and rear ends of the release valve RE via individual pipes, and the solenoid valve SOL may be placed in parallel to the release valve RE.

Thus, the release valve RE and the solenoid valve SOL may be installed in duplicate between the accumulator 220 and the second oil tank T2.

The AC valve AC, AB valve AB, AR valve AR, release valve RE, solenoid valve SOL, etc. of the valve assembly 230 discussed above may all be controlled by the controller 170.

The main pipe 240 is a pipe connected to the cylinder 140. The main pipe 240 may be provided in a single one, and the first line L1 and the fifth line L5 may be formed together in the main pipe 240. Alternatively, the main pipe 240 may consist of two main pipes, and the first line L1 and the fifth line L5 may be formed separately in the respective main pipes. The main pipe 240 may be provided with a joint block 241 at the tip thereof. The large chamber 142 and the small chamber 143 in the cylinder 140 may be connected to the joint block 241.

The oil tank T may consist of one or more oil tanks to store oil introduced thereinto or to discharge the stored oil therefrom.

The oil tank T may include the first oil tank T1 connected to the hydraulic motor 310 of the hydraulic motor assembly 300 via a pipe, the second oil tank T2 connected to the release valve RE via a pipe, the third oil tank T3 connected to the seventh line, and the fourth oil tank T4 connected to the eighth line.

The hydraulic system for recovering boom energy for construction machinery according to the embodiment of the present disclosure may be controlled by a mobile device 400.

The mobile device 400, which is capable of communicating with the controller 170, may be provided outside the construction machine 100, and the valve assembly 230 of the accumulator assembly 200 may be controlled by the controller 170 based on the operation signal of the mobile device 400. The mobile device 400 may include an input means to input a control command and an output means such as a display to display a status of operation of the accumulator assembly 200. For example, the mobile device 400 may be a terminal held by a user, or may be any one of a smartphone, a PDA, a laptop, and a tablet. The mobile device 400 may communicate wirelessly with the controller 170 by means of communication such as Wi-Fi, Bluetooth, Zigbee, beacon, RFID, or the like, and the communication method of the mobile device 400 is not limited thereto.

The controller 170 may control the operation of the construction machine 100 based on the operation signal. For this purpose, the controller 170 may be an electronic control unit (ECU).

Specifically, the controller 170 may control the operations of the hydraulic motor assembly 300 and the accumulator assembly 200 to operate the hydraulic system for recovering boom energy for construction machinery, based on the operation signal from the control operation of the mobile device 400.

The controller 170 may control whether to open or close the boom-up valve 163 or the boom-down valve 164 based on the operation signal from the control operation of the mobile device 400.

In addition, the controller 170 may control the operation of the construction machine 100 and may control whether to open or close the boom-up valve 163 or the boom-down valve 164, based on the operation signal of the joystick 151.

For this purpose, the joystick 151 may be equipped with a first sensor S1 and a second sensor S2. The first sensor S1 may detect a change in pressure during boom-up motion by the joystick 151 to generate an operation signal, and the second sensor S2 may detect a change in pressure during boom-down motion by the joystick 151 to generate an operation signal.

The operation signals generated by the first sensor S1 and the second sensor S2 may be transmitted to the controller 170, and the controller 170 may control whether to open or close the boom-up valve 163 or the boom-down valve 164 based on these operation signals.

Here, the operation signals generated by the first sensor S1 and the second sensor S2 may be transmitted to the mobile device 400 through the controller 170. This may allow the mobile device 400 to control whether to open or close the boom-up valve 163 or the boom-down valve 164.

Meanwhile, the boom-down valve 164 may also be placed in the large chamber line 144. In other words, the boom-down valve 164 may control a flow in the boom-down valve line 166 as well as a flow in the large chamber line 144. In this case, in some situations, when the joystick 151 is operated for boom-down, the controller 170 may control the boom-down valve 164 to close, thereby blocking the flow of oil from the large chamber 142 to the main control valve 160.

By means of the structure described above, a specific mode may be selected through the controller 170, and the controller 170 may control the operations of the hydraulic motor assembly 300 and the accumulator assembly 200, thereby operating the construction machine 100 in various modes.

Here, these various modes may be set, changed, and released by control of the controller 170 through the mobile device 400. In addition, these various modes may be set, changed, and released by control of the controller 170 in response to the operation signal of the joystick 151.

The controller 170 may be operated to recover boom energy during the boom-down motion of the boom in the construction machine 100.

Specifically, the accumulator 220 may be charged with oil to accumulate oil during the boom-down motion of the boom 130, some of the oil introduced into the accumulator 220 during the boom-down motion of the boom 130 may be regenerated and used during boom-up motion, and when the accumulator 220 is full of oil during the boom-down motion of the boom 130, some of the oil introduced into the accumulator 220 may be returned to the oil tank T.

A charging process in the hydraulic system for recovering boom energy for construction machinery during the boom-down motion of the boom according to the embodiment of the present disclosure will be described with reference to FIG. 7.

Potential energy in the event of the boom-down motion of the boom 130 may be recovered to and charged in the accumulator 220, and the stored energy may then be reused. Specifically, the potential energy stored in the accumulator 220 during boom-down may be reused to save fuel and improve performance.

When the boom 130 is moved down, the boom-down valve 164 is closed, oil flows into the small chamber 143 in the cylinder 140 to lower the rod 141 of the cylinder 140, and the oil within the large chamber 142 is discharged through the first line L1 as the rod 141 is lowered.

The oil flowing in the first line L1 may be introduced into the accumulator 220 through the second line L2, and the oil introduced into the accumulator 220 may be accumulated and then reused and utilized.

In this case, since the boom-down valve 164 is locked, oil may be discharged only to the first line L1 without flowing toward the main control valve 160.

This process may allow the potential energy of the boom 130 to be stored in the accumulator 220, and the stored potential energy may be utilized to save fuel or improve performance of the construction machine 100.

A regeneration process in the hydraulic system for recovering boom energy for construction machinery during the boom-down motion of the boom according to the embodiment of the present disclosure will be described with reference to FIG. 8.

During the boom-down motion of the boom 130, oil may flow into the accumulator 220 to store the potential energy of the boom 130 in the accumulator 220, while flowing into the small chamber 143 to increase a boom-down speed.

Specifically, when the boom 130 is moved down, the AB valve AB may be opened to introduce some of the oil flowing in the first line L1 into the small chamber 143 in the cylinder 140 through the sixth line L6 and the fifth line L5, while introducing the remainder of the oil flowing in the first line L1 into the accumulator 220 through the second line L2.

In this way, the boom-down speed of the boom 130 may be increased by the process of accumulating oil in the accumulator 220 and reintroducing oil into the small chamber 143 to rapidly lower the rod 141.

Meanwhile, the eighth line L8 may be further connected to the fifth line L5 and the sixth line L6. The eighth line L8 may be connected to the oil tank T, namely, the fourth oil tank T4. The oil that has passed through the AB valve AB may also flow into the fourth oil tank T4 through the eighth line L8.

A return process in the hydraulic system for recovering boom energy for construction machinery during the boom-down motion of the boom according to the embodiment of the present disclosure will be described with reference to FIG. 9.

If the accumulator 220 is full of oil during the boom-down motion of the boom 130, the oil introduced into the accumulator 220 may be diverted to the third oil tank T3 to facilitate the boom-down of the boom 130.

Specifically, if the accumulator 220 is full of oil during the boom-down motion, the AR valve AR may be opened to introduce some of the oil flowing in the first line L1 into the third oil tank T3 through the seventh line L7.

As such, if the accumulator 220 is full of oil, the boom 130 may no longer be moved down, in which case the oil may be diverted to the third oil tank T3 to facilitate the boom-down of the boom 130.

Here, a fifth sensor S5 may be placed in front of the accumulator 220 in the second line L2. The fifth sensor S5 may measure a pressure in front of the accumulator 220. Thus, the fifth sensor S5 may measure whether the accumulator 220 is full of oil.

Meanwhile, in order to reduce the internal pressure of the accumulator 220, the oil accumulated in the accumulator may be discharged to the outside for pressure release.

Specifically, the release valve RE is opened to reduce the internal pressure of the accumulator 220. Here, it is preferable that the release valve RE be operated in an on/off manner and provided to only be simply opened or closed, rather than precisely adjusting the flow rate of oil, but the present disclosure is not limited thereto.

In this way, the release valve RE may be opened to discharge some of the oil accumulated in the accumulator 220 to the second oil tank T2 through the pipe connecting the accumulator 220 and the second oil tank T2, thereby reducing the pressure within the accumulator 220.

For example, if the pressure of oil introduced into and accumulated in the accumulator 220 exceeds a preset pressure range, the release valve RE may always be opened to introduce some of the oil introduced into the accumulator 220 into the second oil tank T2, thereby reducing the internal pressure of the accumulator 220.

Meanwhile, when it is intended to maintain the construction machine 100, the construction machine 100 may be set to a pressure release mode by allowing the solenoid valve SOL to be opened to introduce all of the oil in the accumulator 220 into the second oil tank T2, and then maintained.

For example, when the construction machine 100 is not in operation or when the construction machine 100, the hydraulic motor assembly 300, or the accumulator assembly 200 is intended to be serviced, it may be serviced after the solenoid valve SOL is opened to introduce all of the oil in the accumulator 220 into the second oil tank T2 to release the internal pressure of the accumulator 220, thereby preventing safety accidents and so on.

As such, even when it is intended to maintain the construction machine 100, the pressure in the accumulator 220 may be released by opening only the release valve RE, by opening only the solenoid valve SOL, or by opening both the release valve RE and the solenoid valve SOL.

Here, the solenoid valve SOL may be closed when the release valve RE is opened, and similarly, the release valve RE may be closed when the solenoid valve SOL is opened.

Meanwhile, the operation of recovery of potential energy in the event of the boom-down of the boom 130 may be temporarily stopped. In other words, referring to FIGS. 2 and 7, during the boom-down motion of the boom 130, the accumulation of oil in the accumulator 220 may be stopped if the boom 130 touches the ground and more force is required for boom-down of the boom 130.

In this case, a third sensor S3 and a fourth sensor S4 may be placed in the first line L1 and the fifth line L5, respectively. The third sensor S3 and the fourth sensor S4 may constantly measure a hydraulic pressure and transmit measured values of hydraulic pressure to the controller 170.

The controller 170 may determine whether the boom 130 touches the ground based on these measured values.

Specifically, if the controller 170 determines that the boom 130 touches the ground, the AC valve AC in the second line L2 connected to the accumulator 220 may be closed to temporarily stop the accumulation of oil in the accumulator 220.

In addition, if the controller 170 determines that the boom 130 touches the ground, both the AC valve AC and the AR valve AR may be closed and the AB valve AB may be opened, so as to introduce the oil discharged from the large chamber 142 only into the small chamber 143 to temporarily stop the accumulation of oil in the accumulator 220.

In other words, the controller 170 may control the AC valve AC placed in the second line L2 and the AR valve AR placed in the seventh line L7 to be closed and only the AB valve AB placed in the sixth line L6 to be opened, so as to introduce all of the oil discharged from the large chamber 142 into the small chamber 143.

While one or more exemplary embodiments have been described with reference to the accompanying drawings, it will be apparent to those skilled in the art that various variations and modifications may be made by adding, changing, or removing components without departing from the spirit and scope of the disclosure as defined in the appended claims, and these variations and modifications fall within the spirit and scope of the disclosure as defined in the appended claims.

What is claimed is:

1. A hydraulic system for recovering boom energy for construction machinery, which is installed in a construction machine to recover energy during boom-down by controlling a flow of oil, wherein the construction machine comprises a cylinder comprising a rod raised and lowered by means of the flow of oil, a large chamber, and a small chamber formed on the large chamber, an engine configured to provide the flow of oil to the cylinder, and an accumulator connected to the cylinder and the engine to accumulate oil, the hydraulic system comprising:
a main control valve connected to the cylinder to selectively control the flow of oil provided to the cylinder;
a hydraulic motor assembly connected to the engine to provide the engine with a rotational force generated by means of a fluid;
a main pipe connected to the cylinder; and
a valve assembly comprising a plurality of lines connected to the main pipe and through which oil flows, and a valve installed in a selected one of the plurality of lines.

2. The hydraulic system according to claim 1, wherein the valve assembly comprises a first line having one side connected to the large chamber in the cylinder, a second line connecting the first line and the accumulator, a fifth line having one side connected to the small chamber in the cylinder, a sixth line branched from the first line and connected to the fifth line, and a seventh line branched from the first line and connected to an oil tank.

3. The hydraulic system according to claim 2, wherein the second line is provided with an AC valve that controls a flow rate of oil.

4. The hydraulic system according to claim 3, wherein when the boom is moved down, the AC valve is opened to control the flow rate of oil such that the oil discharged from the cylinder flows only toward the accumulator through the first line and the second line, thereby charging the accumulator with oil.

5. The hydraulic system according to claim 2, wherein the sixth line is provided with an AB valve that controls a flow rate of oil.

6. The hydraulic system according to claim 5, wherein when the boom is moved down, the AB valve is opened to control the flow rate of oil such that the oil discharged from the large chamber in the cylinder flows into the accumulator through the first line, and at the same time, some of the oil flows into the small chamber through the sixth line and the fifth line, thereby regenerating oil.

7. The hydraulic system according to claim 2, wherein the seventh line is provided with an AR valve that controls a flow rate of oil.

8. The hydraulic system according to claim 7, wherein when the boom is moved down, the AR valve is opened if the accumulator is full of the oil introduced through the first line and the second line, thereby controlling the flow rate of oil flowing to the accumulator to return some of the oil to the oil tank.

9. The hydraulic system according to claim 1, wherein:
the hydraulic motor assembly comprises a variable hydraulic motor configured to generate a rotational force when oil is introduced thereinto; and
the variable hydraulic motor is controlled in torque to adjust an amount of oil introduced thereinto.
